(19) United States
(12) Patent Application Publication
(10) Pub. No.: US 2018/0203941 A1
(43) Pub. Date: Jul. 19, 2018

(54) ELECTRONIC DEVICE AND METHOD FOR CREATING SHORTCUT TO WEB PAGE IN ELECTRONIC DEVICE

(71) Applicant: Samsung Electronics Co., Ltd, Suwon-si (KR)

(72) Inventors: Deung Hyeon JEONG, Suwon-si (KR); Yu Youl EOM, Yongin-si (KR); Kwang Sub KIM, Yongin-si (KR); Hak Sub KIM, Suwon-si (KR); Byeong Jun MUN, Suwon-si (KR); Sei Jin LEE, Seoul (KR); Yoon Ju LEE, Bucheon-si (KR)

(21) Appl. No.: 15/872,788

(22) Filed: Jan. 16, 2018

(30) Foreign Application Priority Data
Jan. 16, 2017 (KR) 10-2017-0007211

(51) Int. Cl. G06F 17/30; H04L 29/08; G06F 21/62; H04L 29/12

(52) U.S. Cl. CPC G06F 17/30887; H04L 61/308; G06F 21/6263; H04L 67/02

(57) ABSTRACT

An electronic device, a method, and a non-transitory computer-readable medium are disclosed. The electronic device includes a communication circuit, a memory, a display, and at least one processor. The memory is configured to store an application. The at least one processor is configured to receive data about a web page through the application using the communication circuit. The at least one processor is also configured to receive an input for creating a shortcut to the web page. The at least one processor is further configured to encrypt at least a part of the data about the web page that includes a uniform resource identifier (URI) of the web page, based on the input. The at least one processor is also configured to create the shortcut to the web page associated with the encrypted data.

### CROSS-REFERENCE TO RELATED APPLICATION(S)

This application is related to and claims priority to Korean Patent Application No. 10-2017-0007211 filed on Jan. 16, 2017, the entire disclosure of which is hereby incorporated by reference.

### TECHNICAL FIELD

Embodiments disclosed herein relate to a technology for creating a shortcut to a web page.

### BACKGROUND

Wireless communication technologies enable transmission and reception of various forms of information, such as text, an image, a video, speech, and the like. These wireless communication technologies have been developed to more rapidly transmit and receive more information. With the development of the wireless communication technologies, electronic devices, such as a smartphone, a tablet PC, a wearable device, and the like, which are able to perform wireless communication may provide services using a communication function, such as Wi-Fi, long-term evolution (LTE), or the like. The aforementioned electronic devices may access a web page through wireless communication and may output various information included in the web page using a browser.

### SUMMARY

An electronic device may create a shortcut for accessing a web page. The shortcut may be located, for example, on the home screen of the electronic device. If the shortcut is located at a position, such as the home screen, which is easily exposed to another person, it may be difficult to protect privacy of a user of the electronic device.

Aspects of the present disclosure are to address at least the above-mentioned problems and/or disadvantages and to provide at least the advantages described below. According to this disclosure, it is an object to provide an electronic device and a method for creating a web-page shortcut capable of protecting a user's privacy.

In accordance with an aspect of the present disclosure, an electronic device includes a communication circuit, a memory in which an application is stored, a display, and at least one processor electrically connected with the communication circuit, the memory, and the display. The memory stores instructions that allow the at least one processor to receive data about a web page through the application by using the communication circuit, to receive an input for creating a shortcut to the web page, to encrypt at least a part of the data about the web page that includes a uniform resource identifier (URI) of the web page, based on the input, and to create the shortcut to the web page that is associated with the encrypted data about the web page.

In accordance with another aspect of the present disclosure, a method includes accessing the web page through an application from a server, obtaining data about the web page that includes a URI of the web page, encrypting at least a part of the data about the web page, and creating a shortcut to the web page that is associated with the encrypted data about the web page.

In accordance with another aspect of the present disclosure, a storage medium stores an instruction that is to be executed by at least one processor included in an electronic device, in which the instruction allows the at least one processor to access a web page through an application from a server, to obtain data about the web page that includes a URI of the web page, to encrypt at least a part of the data about the web page, and to create a shortcut to the web page that is associated with the encrypted data about the web page.

According to an embodiment of the present disclosure, by changing at least a part of data associated with a shortcut when creating the shortcut in an electronic device, it is possible to protect privacy of a user of the electronic device.

According to an embodiment of the present disclosure, by performing user authentication when the shortcut is executed, it is possible to protect privacy of the user of the electronic device.

According to an embodiment of the present disclosure, by checking the safety of a web page connected with the shortcut, it is possible to prevent access to a dangerous web page.

In addition, the present disclosure may provide various effects that are directly or indirectly recognized.

Other aspects, advantages, and salient features of the disclosure will become apparent to those skilled in the art from the following detailed description, which, taken in conjunction with the annexed drawings, discloses various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an electronic device in a network environment according to an embodiment of the present disclosure;

FIG. 2 illustrates a block diagram of an electronic device according to an embodiment of the present disclosure;

FIG. 3 illustrates a block diagram of a program module according to an embodiment of the present disclosure;

FIG. 4 illustrates a block diagram of a configuration of an electronic device according to an embodiment of the present disclosure;

FIG. 5 illustrates a block diagram of a configuration of a browser installed in an electronic device, according to an embodiment of the present disclosure;

FIG. 6 illustrates an exemplary document included in a web page connected with an electronic device, according to an embodiment of the present disclosure;

FIG. 7 illustrates an exemplary user interface provided by an electronic device when a shortcut is created or executed according to an embodiment of the present disclosure;

FIG. 8 illustrates a web page connected with an electronic device and a shortcut to the web page, according to an embodiment of the present disclosure;

FIG. 9 illustrates a web page connected with an electronic device and a shortcut to the web page, according to an embodiment of the present disclosure;

FIG. 10 illustrates a web page connected with an electronic device, a shortcut to the web page, and a user interface for authentication, according to an embodiment of the present disclosure;

FIG. 11 illustrates a flowchart of a method for creating a shortcut to a web page in an electronic device, according to an embodiment of the present disclosure;

FIG. 12 illustrates a flowchart of a method for creating a shortcut to a web page in an electronic device, according to an embodiment of the present disclosure;

FIG. 13 illustrates a flowchart of a method for creating a shortcut to a web page in an electronic device, according to an embodiment of the present disclosure; and

FIG. 14 illustrates a flowchart of a method for executing a shortcut to a web page in an electronic device, according to an embodiment of the present disclosure.

Throughout the drawings, it should be noted that like reference numbers are used to depict the same or similar elements, features, and structures.

### DETAILED DESCRIPTION

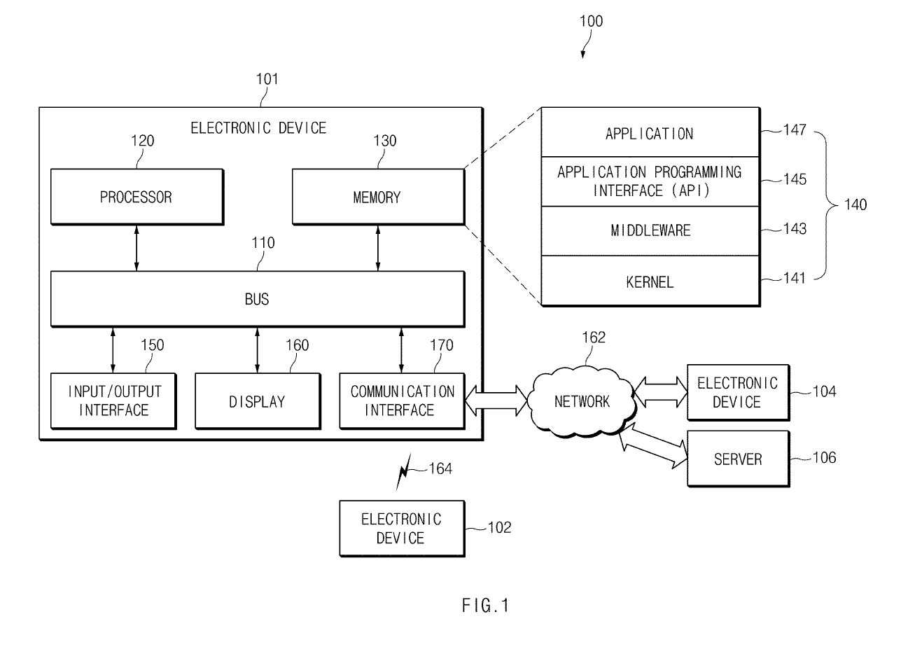

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar elements may be marked by similar reference numerals. The terms of a singular form may include plural forms unless otherwise specified. In this disclosure, the expressions “A or B”, “at least one of A or/and B”, or “one or more of A or/and B”, and the like may include any and all combinations of one or more of the associated listed items. The terms, such as “first”, “second”, and the like may be used to refer to various elements regardless of the order and/or the priority and to distinguish the relevant elements from other elements, but do not limit the elements. When an element (e.g., a first element) is referred to as being “(operatively or communicatively) coupled with/to” or “connected to” another element (e.g., a second element), the element may be directly coupled with/to or connected to the other element or an intervening element (e.g., a third element) may be present.

According to the situation, the expression “configured to” used in this disclosure may be used as, for example, the expression “suitable for”, “having the capacity to”, “adapted to”, “made to”, “capable of”, or “designed to” in hardware or softwre. The expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

An electronic device according to various embodiments of this disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, medical devices, cameras, or wearable devices. According to various embodiments, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or a bio-implantable type (e.g., an implantable circuit). According to various embodiments, the electronic device may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, media boxes (e.g., SAMSUNG HOMESYNC, APPLE TV, or GOOGLE TV), game consoles (e.g., XbOX or PLAYSTATION), electronic dictionaries, electronic keys, camcorders, electronic picture frames, and the like.

According to another embodiment, an electronic device may include at least one of various medical devices (e.g., various portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, Global Navigation Satellite System (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, drones, automatic teller's machines (ATMs), points of sales (POSs) of stores, or internet of things (e.g., light bulbs, various sensors, sprinkler devices, fire alarms, thermostats, street lamps, toasters, exercise equipment, hot water tanks, heaters, boilers, and the like).According to an embodiment, the electronic device may include at least one of parts of furniture or buildings/structures, electronic boards, electronic signature receiving devices, projectors, or various measuring instruments (e.g., water meters, electricity meters, gas meters, or wave meters, and the like). According to various embodiments, the electronic device may be a flexible electronic device or a combination of two or more above-described devices. Furthermore, an electronic device according to an embodiment of this disclosure may not be limited to the above-described electronic devices. In this disclosure, the term “user” may refer to a person who uses an electronic device or may refer to a device (e.g., an artificial intelligence electronic device) that uses the electronic device.

Referring to FIG. 1, according to various embodiments, an electronic device 101 in a network environment is described. The electronic device 101 may include a bus 110, a processor 120, a memory 130, an input/output interface 150, a display 160, and a communication interface 170. According to an embodiment, the electronic device 101 may not include at least one of the above-described elements or may further include other element(s). The bus 110 may interconnect the above-described elements 110 to 170 and may include a circuit for conveying communications (e.g., a control message and/or data) among the above-described elements. The processor 120 may include one or more of a central processing unit (CPU), an application processor (AP), or a communication processor (CP). For example, the processor 120 may perform an arithmetic operation or data processing associated with control and/or communication of at least other elements of the electronic device 101.

The memory 130 may include a volatile and/or nonvolatile memory. For example, the memory 130 may store instructions or data associated with at least one other element(s) of the electronic device 101. According to an embodiment, the memory 130 may store software and/or a program 140. The program 140 may include, for example, a kernel 141, a middleware 143, an application programming interface (API) 145, and/or an application program (or “an application”) 147. At least a part of the kernel 141, the middleware 143, or the API 145 may be referred to as an “operating system (OS)”. For example, the kernel 141 may control or manage system resources (e.g., the bus 110, the processor 120, the memory 130, and the like) that are used to execute operations or functions of other programs (e.g., the middleware 143, the API 145, and the application program 147). Furthermore, the kernel 141 may provide an interface that allows the middleware 143, the API 145, or the application program 147 to access discrete elements of the electronic device 101 so as to control or manage system resources.

The middleware 143 may perform, for example, a mediation role such that the API 145 or the application program 147 communicates with the kernel 141 to exchange data. Furthermore, the middleware 143 may process one or more task requests received from the application program 147 according to a priority. For example, the middleware 143 may assign the priority, which makes it possible to use a system resource (e.g., the bus 110, the processor 120, the memory 130, or the like) of the electronic device 101, to at least one of the application program 147 and may process the one or more task requests. The API 145 may be an interface through which the application program 147 controls a function provided by the kernel 141 or the middleware 143, and may include, for example, at least one interface or function (e.g., a command) for a file control, a window control, image processing, a character control, or the like. The input/output interface 150 may transmit an instruction or data input from a user or another external device, to other element(s) of the electronic device 101 or may output an instruction or data, received from other element(s) of the electronic device 101, to a user or another external device.

The display 160 may include, for example, a liquid crystal display (LCD), a light-emitting diode (LED) display, an organic LED (OLED) display, a microelectromechanical systems (MEMS) display, or an electronic paper display. The display 160 may display, for example, various contents (e.g., a text, an image, a video, an icon, a symbol, and the like) to a user. The display 160 may include a touch screen and may receive, for example, a touch, gesture, proximity, or hovering input using an electronic pen or a part of a user's body. For example, the communication interface 170 may establish communication between the electronic device 101 and an external device (e.g., the first electronic device 102, the second electronic device 104, or the server 106). For example, the communication interface 170 may be connected to the network 162 over wireless communication or wired communication to communicate with the external device (e.g., the second electronic device 104 or the server 106).

For example, the wireless communication may include cellular communication using at least one of long-term evolution (LTE), LTE Advanced (LTE-A), Code Division Multiple Access (CDMA), Wideband CDMA (WCDMA), Universal Mobile Telecommunications System (UMTS), Wireless Broadband (WiBro), Global System for Mobile Communications (GSM), or the like. The wireless communication as illustrated by an element 164 of FIG. 1 may include at least one of wireless fidelity (Wi-Fi), light fidelity (LiFi), Bluetooth, Bluetooth low energy (BLE), Zigbee, near field communication (NFC), magnetic stripe transmission (MST), radio frequency (RF), a body area network, or the like. According to an embodiment, the wireless communication may include GNSS. The GNSS may be one of, for example, a global positioning system (GPS), a global navigation satellite system (Glonass), a Beidou navigation satellite system (hereinafter referred to as “Beidou”), or an European global satellite-based navigation system (hereinafter referred to as “Galileo”). Hereinafter, in this disclosure, “GPS” and “GNSS” may be interchangeably used. The wired communication may include at least one of, for example, a universal serial bus (USB), a high definition multimedia interface (HDMI), a recommended standard-232 (RS-232), power line communication, a plain old telephone service (POTS), or the like. The network 162 may include at least one of telecommunications networks, for example, a computer network (e.g., LAN or WAN), an Internet, or a telephone network.

Each of the first and second electronic devices 102 and 104 may be a device of which the type is different from or the same as that of the electronic device 101. According to various embodiments, all or a portion of operations that the electronic device 101 will perform may be executed by another or plural electronic devices (e.g., the first electronic device102, the second electronic device 104 or the server 106). According to an embodiment, in the case where the electronic device 101 executes any function or service automatically or in response to a request, the electronic device 101 may not perform the function or the service internally, but, alternatively additionally, it may request at least a portion of a function associated with the electronic device 101 at other electronic device (e.g., the electronic device 102 or 104 or the server 106). The other electronic device (e.g., the electronic device 102 or 104 or the server 106) may execute the requested function or additional function and may transmit the execution result to the electronic device 101. The electronic device 101 may provide the requested function or service using the received result or may additionally process the received result to provide the requested function or service. To this end, for example, cloud computing, distributed computing, or client-server computing may be used.

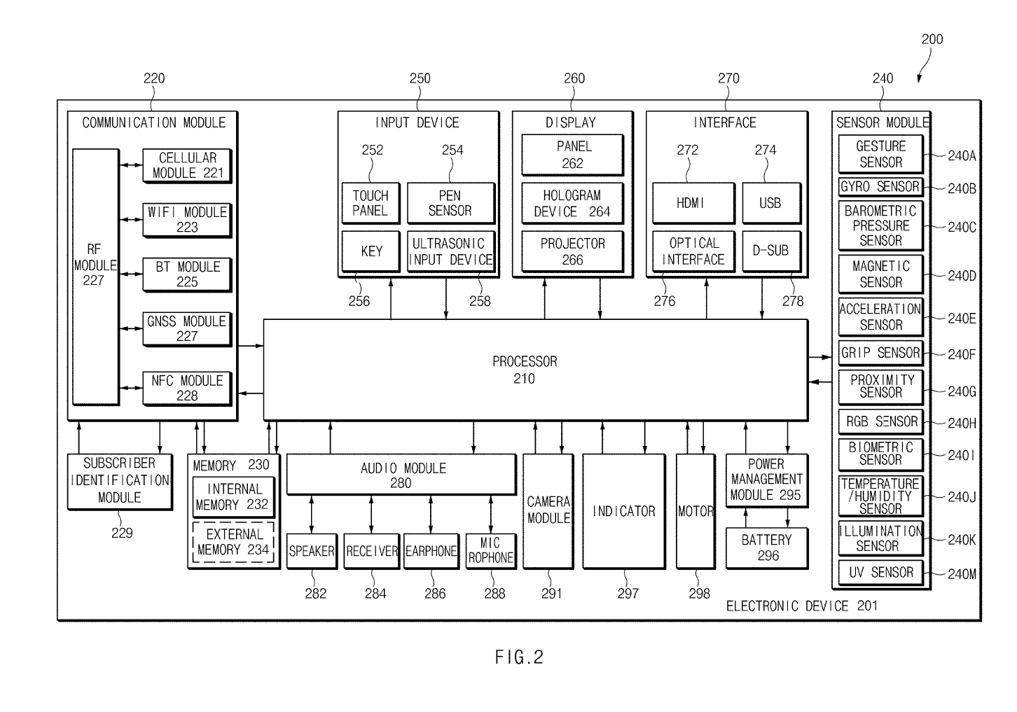

FIG. 2 illustrates a block diagram of an electronic device, according to an embodiment of the present disclosure. An electronic device 201 may include, for example, all or a part of the electronic device 101 illustrated in FIG. 1. The electronic device 201 may include one or more processors (e.g., an application processor (AP)) 210, a communication module 220, a subscriber identification module 224, a memory 230, a sensor module 240, an input device 250, a display 260, an interface 270, an audio module 280, a camera module 291, a power management module 295, a battery 296, an indicator 297, and a motor 298.For example, the processor 210 may be implemented with a System on Chip (SoC). According to an embodiment, the processor 210 may further include a graphic processing unit (GPU) and/or an image signal processor. The processor 210 may include at least a part (e.g., a cellular module 221) of elements illustrated in FIG. 2. The processor 210 may load an instruction or data, which is received from at least one of other elements (e.g., a nonvolatile memory), into a volatile memory and process the loaded instruction or data. The processor 210 may store result data in the nonvolatile memory.

The communication module 220 may be configured the same as or similar to the communication interface 170 of FIG. 1. The communication module 220 may include the cellular module 221, a Wi-Fi module 223, a Bluetooth (BT) module 225, a GNSS module 227, a near field communication (NFC) module 228, and a radio frequency (RF) module 229.The cellular module 221 may provide, for example, voice communication, video communication, a character service, an Internet service, or the like over a communication network. According to an embodiment, the cellular module 221 may perform discrimination and authentication of the electronic device 201 within a communication network by using the subscriber identification module (e.g., a SIM card) 224. According to an embodiment, the cellular module 221 may perform at least a portion of functions that the processor 210 provides. According to an embodiment, the cellular module 221 may include a communication processor (CP). According to an embodiment, at least a part (e.g., two or more) of the cellular module 221, the Wi-Fi module 223, the BT module 225, the GNSS module 227, or the NFC module 228 may be included within one Integrated Circuit (IC) or an IC package. For example, the RF module 229 may transmit and receive a communication signal (e.g., an RF signal). For example, the RF module 229 may include a transceiver, a power amplifier module (PAM), a frequency filter, a low noise amplifier (LNA), an antenna, or the like. According to another embodiment, at least one of the cellular module 221, the Wi-Fi module 223, the BT module 225, the GNSS module 227, or the NFC module 228may transmit and receive an RF signal through a separate RF module. The subscriber identification module 224 may include, for example, a card and/or embedded SIM that includes a subscriber identification module and may include unique identify information (e.g., integrated circuit card identifier (ICCID)) or subscriber information (e.g., international mobile subscriber identity (IMSI)).

The memory 230 (e.g., the memory 130) may include an internal memory 232 or an external memory 234. For example, the internal memory 232 may include at least one of a volatile memory (e.g., a dynamic random access memory (DRAM), a static RAM (SRAM), a synchronous DRAM (SDRAM), or the like), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory, a hard drive, or a solid state drive (SSD).The external memory 234 may include a flash drive such as compact flash (CF), secure digital (SD), micro secure digital (Micro-SD), mini secure digital (Mini-SD), extreme digital (xD), a multimedia card (MMC), a memory stick, or the like. The external memory 234 may be operatively and/or physically connected to the electronic device 201 through various interfaces.

The sensor module 240 may measure, for example, a physical quantity or may detect an operation state of the electronic device 201. The sensor module 240 may convert the measured or detected information to an electric signal. For example, the sensor module 240 may include at least one of a gesture sensor 240A, a gyro sensor 240B, a barometric pressure sensor 240C, a magnetic sensor 240D, an acceleration sensor 240E, a grip sensor 240F, the proximity sensor 240G, a color sensor 240H (e.g., red, green, blue (RGB) sensor), a biometric sensor 240I, a temperature/humidity sensor 240J, an illuminance sensor 240K, or an UV sensor 240M. Although not illustrated, additionally or generally, the sensor module 240 may further include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling at least one or more sensors included therein. According to an embodiment, the electronic device 201 may further include a processor that is a part of the processor 210 or independent of the processor 210 and is configured to control the sensor module 240. The processor may control the sensor module 240 while the processor 210 remains at a sleep state.

The input device 250 may include, for example, a touch panel 252, a (digital) pen sensor 254, a key 256, or an ultrasonic input unit 258. For example, the touch panel 252 may use at least one of capacitive, resistive, infrared and ultrasonic detecting methods. Also, the touch panel 252 may further include a control circuit. The touch panel 252 may further include a tactile layer to provide a tactile reaction to a user. The (digital) pen sensor 254 may be, for example, a part of a touch panel or may include an additional sheet for recognition. The key 256 may include, for example, a physical button, an optical key, or a keypad. The ultrasonic input unit 258 may detect (or sense) an ultrasonic signal, which is generated from an input device, through a microphone (e.g., a microphone 288) and may check data corresponding to the detected ultrasonic signal.

The display 260 (e.g., the display 160) may include a panel 262, a hologram device 264, a projector 266, and/or a control circuit for controlling the panel 262, the hologram device 264, or the projector 266. The panel 262 may be implemented, for example, to be flexible, transparent or wearable. The panel 262 and the touch panel 252 may be integrated into a single module. According to an embodiment, the panel 262 may include a pressure sensor (or force sensor) that measures the intensity of touch pressure by a user. The pressure sensor may be implemented integrally with the touch panel 252, or may be implemented as at least one sensor separately from the touch panel 252.The hologram device 264 may display a stereoscopic image in a space using a light interference phenomenon. The projector 266 may project light onto a screen so as to display an image. For example, the screen may be arranged in the inside or the outside of the electronic device 201. The interface 270 may include, for example, a high-definition multimedia interface (HDMI) 272, a universal serial bus (USB) 274, an optical interface 276, or a D-subminiature (D-sub) 278. The interface 270 may be included, for example, in the communication interface 170 illustrated in FIG. 1. Additionally or generally, the interface 270 may include, for example, a mobile high definition link (MHL) interface, a SD card/multi-media card (MMC) interface, or an infrared data association (IrDA) standard interface.

The audio module 280 may convert a sound and an electric signal in dual directions. At least a part of the audio module 280 may be included, for example, in the input/output interface 150 illustrated in FIG. 1. The audio module 280 may process, for example, sound information that is input or output through a speaker 282, a receiver 284, an earphone 286, or the microphone 288.For example, the camera module 291 may shoot a still image or a video. According to an embodiment, the camera module 291 may include at least one or more image sensors (e.g., a front sensor or a rear sensor), a lens, an image signal processor (ISP), or a flash (e.g., an LED or a xenon lamp). The power management module 295 may manage, for example, power of the electronic device 201. According to an embodiment, a power management integrated circuit (PMIC), a charger IC, or a battery or fuel gauge may be included in the power management module 295. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, a rectifier, or the like. The battery gauge may measure, for example, a remaining capacity of the battery 296 and a voltage, current or temperature thereof while the battery is charged. The battery 296 may include, for example, a rechargeable battery and/or a solar battery.

The indicator 297 may display a specific state of the electronic device 201 or a part thereof (e.g., the processor 210), such as a booting state, a message state, a charging state, and the like. The motor 298 may convert an electrical signal into a mechanical vibration and may generate the following effects: vibration, haptic, and the like. The electronic device 201 may include a processing device (e.g., a GPU) for supporting a mobile TV. The processing device for supporting the mobile TV may process media data according to the standards of digital multimedia broadcasting (DMB), digital video broadcasting (DVB), MEDIAFLO, or the like. Each of the above-mentioned elements of the electronic device according to various embodiments of the present disclosure may be configured with one or more components, and the names of the elements may be changed according to the type of the electronic device. In various embodiments, some elements of the electronic device (e.g., the electronic device 201) may be omitted or other additional elements may be added. Furthermore, some of the elements of the electronic device may be combined with each other so as to form one entity, so that the functions of the elements may be performed in the same manner as before the combination.

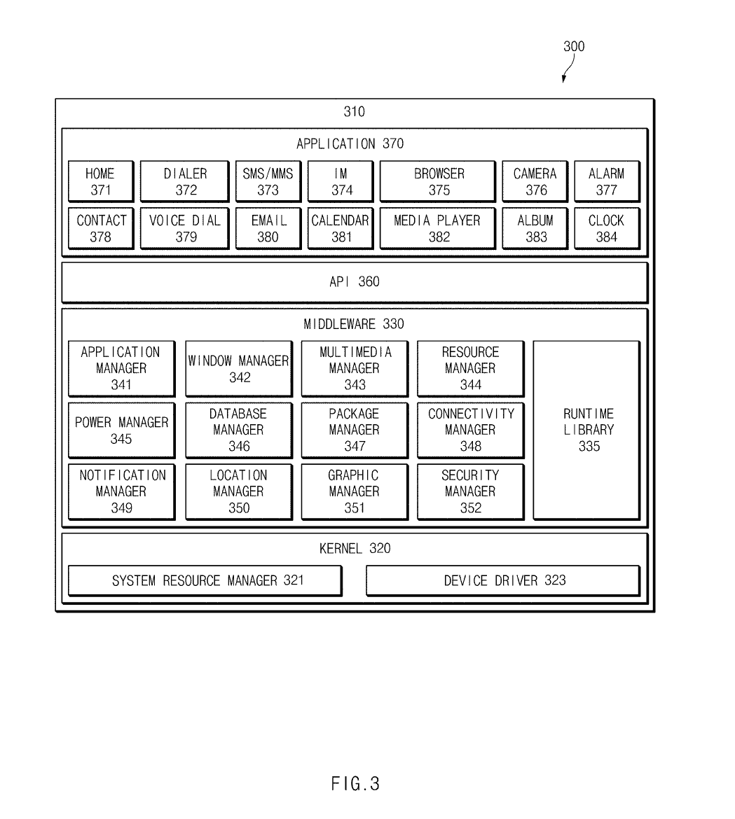

FIG. 3 illustrates a block diagram of a program module, according to an embodiment of the present disclosure. According to an embodiment, a program module 310 (e.g., the program 140) may include an operating system (OS) to control resources associated with an electronic device (e.g., the electronic device 101), and/or diverse applications (e.g., the application program 147) driven on the OS. The OS may be, for example, ANDROID, IOS, WINDOWS, SYMBIAN, TIZEN, or BADA. The program module 310 may include a kernel 320 (e.g., the kernel 141), a middleware 330 (e.g., the middleware 143), an application programming interface (API) 360 (e.g., the API 145), and/or an application 370 (e.g., the application program 147). At least a portion of the program module 310 may be preloaded on an electronic device or may be downloadable from an external electronic device (e.g., the first electronic device 102, the second electronic device 104, the server 106, or the like).

The kernel 320 (e.g., the kernel 141) may include, for example, a system resource manager 321 or a device driver 323. The system resource manager 321 may control, allocate, or retrieve system resources. According to an embodiment, the system resource manager 321 may include a process managing unit, a memory managing unit, a file system managing unit, or the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver. The middleware 330 may provide, for example, a function that the application 370 needs in common, or may provide diverse functions to the application 370 through the API 360 to allow the application 370 to efficiently use limited system resources of the electronic device. According to an embodiment, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include, for example, a library module that is used by a compiler to add a new function through a programming language while the application 370 is being executed. The runtime library 335 may perform input/output management, memory management, or capacities about arithmetic functions. The application manager 341 may manage, for example, a life cycle of at least one application of the application 370. The window manager 342 may manage a graphic user interface (GUI) resource that is used in a screen. The multimedia manager 343 may identify a format necessary for playing diverse media files, and may perform encoding or decoding of media files by using a codec suitable for the format. The resource manager 344 may manage resources such as a memory space or source code of the application 370. The power manager 345 may manage a battery or power, and may provide power information for an operation of an electronic device. According to an embodiment, the power manager 345 may operate with a basic input/output system (BIOS). The database manager 346 may generate, search for, or modify database that is to be used in the application 370. The package manager 347 may install or update an application that is distributed in the form of package file.

The connectivity manager 348 may manage, for example, wireless connection. The notification manager 349 may provide an event, for example, arrival message, appointment, or proximity notification to a user. For example, the location manager 350 may manage location information about an electronic device. The graphic manager 351 may manage a graphic effect that is provided to a user, or manage a user interface relevant thereto. The security manager 352 may provide, for example, system security or user authentication. According to an embodiment, the middleware 330 may include a telephony manager for managing a voice or video call function of the electronic device or a middleware module that combines diverse functions of the above-described elements. According to an embodiment, the middleware 330 may provide a module specialized to each OS kind to provide differentiated functions. Additionally, the middleware 330 may dynamically remove a part of the preexisting elements or may add new elements thereto. The API 360 may be, for example, a set of programming functions and may be provided with a configuration that is variable depending on an OS. For example, in the case where an OS is the android or the iOS, it may provide one API set per platform. In the case where an OS is the tizen, it may provide two or more API sets per platform.

The application 370 may include, for example, applications such as a home 371, a dialer 372, an SMS/MMS 373, an instant message (IM) 374, a browser 375, a camera 376, an alarm 377, a contact 378, a voice dial 379, an e-mail 380, a calendar 381, a media player 382, an album 383, a watch 384, health care (e.g., measuring an exercise quantity, blood sugar, or the like) or offering of environment information (e.g., information of barometric pressure, humidity, temperature, or the like). According to an embodiment, the application 370 may include an information exchanging application to support information exchange between an electronic device and an external electronic device. The information exchanging application may include, for example, a notification relay application for transmitting specific information to an external electronic device, or a device management application for managing the external electronic device. For example, the notification relay application may include a function of transmitting notification information, which arise from other applications, to an external electronic device or may receive, for example, notification information from an external electronic device and provide the notification information to a user. The device management application may install, delete, or update for example, a function (e.g., turn-on/turn-off of an external electronic device itself (or a part of components) or adjustment of brightness (or resolution) of a display) of the external electronic device which communicates with the electronic device, and an application running in the external electronic device. According to an embodiment, the application 370 may include an application (e.g., a health care application of a mobile medical device) that is assigned in accordance with an attribute of an external electronic device. According to an embodiment, the application 370 may include an application that is received from an external electronic device. At least a portion of the program module 310 may be implemented by software, firmware, hardware (e.g., the processor 210), or a combination (e.g., execution) of two or more thereof, and may include modules, programs, routines, sets of instructions, processes, or the like for performing one or more functions.

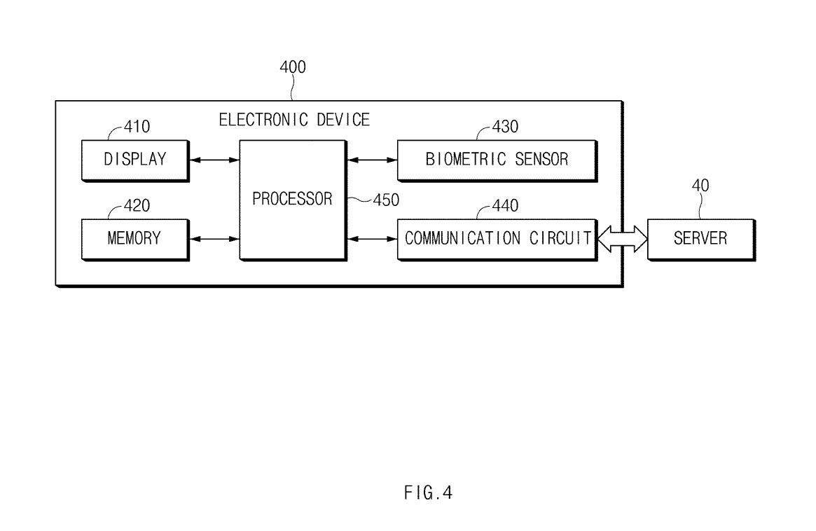

FIG. 4 illustrates a block diagram of a configuration of an electronic device according to an embodiment of the present disclosure.

Referring to FIG. 4, an electronic device 400 (e.g., the electronic device 101 or 102 of FIG.1 or the electronic device 201 of FIG. 2) according to an embodiment may include a display 410, a memory 420, a biometric sensor 430, a communication circuit 440, and a processor 450. The electronic device 400 may be one of various types of devices, such as a desktop computer, a laptop computer, a smartphone, a tablet PC, and the like.

The display 410 may output an image. For example, the display 410 may display an execution screen of a browser or an application installed in the electronic device 400. The display 410 may display a web page rendered by the browser.

The memory 420 may store data. The memory 420 may include a volatile memory and/or a non-volatile memory. The memory 420 may store, for example, a browser. The memory 420 may store data about a web page connected through the browser. For example, the memory 420 may store cache data about the web page connected through the browser.

The biometric sensor 430 may sense biometric information. For example, the biometric sensor 430 may sense at least some of various pieces of biometric information, such as a fingerprint, an iris, a face, and the like. The electronic device 400 may include two or more biometric sensors.

The communication circuit 440 may communicate with a server 40. The communication circuit 440 may communicate with the server 40 having a web page stored therein. The communication circuit 440 may perform communication by various communication methods, such as 3rd generation (3G), long term evolution (LTE), Wi-Fi, and the like.

The processor 450 may be electrically connected with the display 410, the memory 420, the biometric sensor 430, and the communication circuit 440. The processor 450 may control the display 410, the memory 420, the biometric sensor 430, and the communication circuit 440 and may execute applications stored in the memory 420 to perform various operations.

According to an embodiment, the processor 450 may receive a web page from the server 40 through a browser by using the communication circuit 440. The processor 450 may execute the browser. For example, the processor 450 may access a web page corresponding to a uniform resource identifier (URI) input through the browser. In another example, the processor 450 may access a web page linked to a hyperlink displayed on the browser. The web page may be a web application (e.g., a progressive web application (PWA)).

According to an embodiment, the processor 450 may obtain data about the received web page that includes the URI of the web page. For example, the processor 450 may obtain data about the web page that includes information about the URI, the icon, and the name of the web page. The processor 450 may also obtain cache data about the received web page.

According to an embodiment, the processor 450 may obtain the data about the web page by using the browser. For example, the processor 450, when accessing the web page, may obtain the data about the web page that includes information about the URI, the icon, and the name of the web page. In another example, the processor 450 may obtain the data about the web page if a shortcut creation function embedded in the browser is executed.

According to an embodiment, the processor 450 may obtain the data about the web page on the basis of a web application manifest corresponding to the web page. For example, the processor 450, when accessing the web page, may obtain the web application manifest corresponding to the web page. The web application manifest may be a file created on the basis of a web standard, such as World Wide Web consortium (W3C) standard. For example, the web application manifest may be a file created in the javascript object notation (JSON) format. The web application manifest may be provided by a content provider of the web application. The processor 450 may parse the web application manifest. The processor 450 may obtain data about the web application associated with the web page that includes information about the icon and/or the name of the web application, by parsing the web application manifest.

According to an embodiment, the processor 450 may obtain the data about the web application through a distribution platform of the web application. For example, the processor 450 may obtain the data about the web application through a content store for selling or providing a web application.

According to an embodiment, the processor 450 may encrypt at least a part of the data about the web page. For example, the processor 450 may output, on the display 410, a user interface including an option for selecting whether to perform encryption. If a user sets encryption through the user interface, the processor 450 may encrypt at least a part of the data about the web page. In another example, if the web page is received while the browser is operating in a secret mode, the processor 450 may automatically encrypt at least a part of the data about the web page. In the case where the processor 450 accesses the web page in the state in which the browser is in the secret mode, the processor 450 may encrypt at least a part of the data about the web page when creating a shortcut. In another example, if the web page is received while the browser is operating in a normal mode rather than the secret mode, the processor 450 may encrypt at least a part of the data about the web page after authenticating the user by using biometric information, a personal identification number (PIN), or an authentication pattern. The processor 450 may encrypt, for example, the URI of the web page. The processor 450 may encrypt the URI by using a key managed by the browser.

According to an embodiment, the processor 450 may create a shortcut to the web page that is associated with the encrypted data about the web page. The processor 450 may create metadata of the shortcut that includes the URI, the icon, and the name of the web page that have been encrypted. The processor 450 may dispose the created shortcut on the home screen or at a position specified by the user.

According to an embodiment, if an input is applied to the shortcut output on the display 410, the processor 450 may perform authentication on the user of the electronic device 400. If the user applies a touch input to the shortcut output on the display 410 to open the web page connected with the shortcut, the processor 450 may recognize the touch input on the shortcut. The processor 450 may authenticate the user of the electronic device 400 by using the user's biometric information, PIN, or authentication pattern.

According to an embodiment, the processor 450 may decode the encrypted data about the web page if the user authentication is completed. The processor 450 may complete the authentication if the biometric information, the PIN, or the authentication pattern input by the user is identical to the biometric information, the PIN, or the authentication pattern stored in the memory 420. The processor 450 may decode the encrypted data by using the key used to encrypt the data. For example, the processor 450 may obtain the URI of the web page by decoding the encrypted data.

According to an embodiment, the processor 450 may output the web page corresponding to the decoded data on the display 410 through the browser. The processor 450 may access the web page corresponding to the decoded URI through the browser. The processor 450 may render the web page by using the browser and may output the web page on the display 410. The processor 450 may operate the browser in a secret mode and may output the web page in the secret mode of the browser.

According to an embodiment, in the case where the processor 450 is connected with the web page through the shortcut created by the above-described operations, the processor 450 may manage the corresponding web page and a history, a cookie, log-in data (e.g., an ID and a password), and cache data for the web page, which are associated with the corresponding web page, separately from data about another web page. For example, the processor 450 may individually manage the above-described data on a URI-by-URI basis by using the browser and may not store a history.

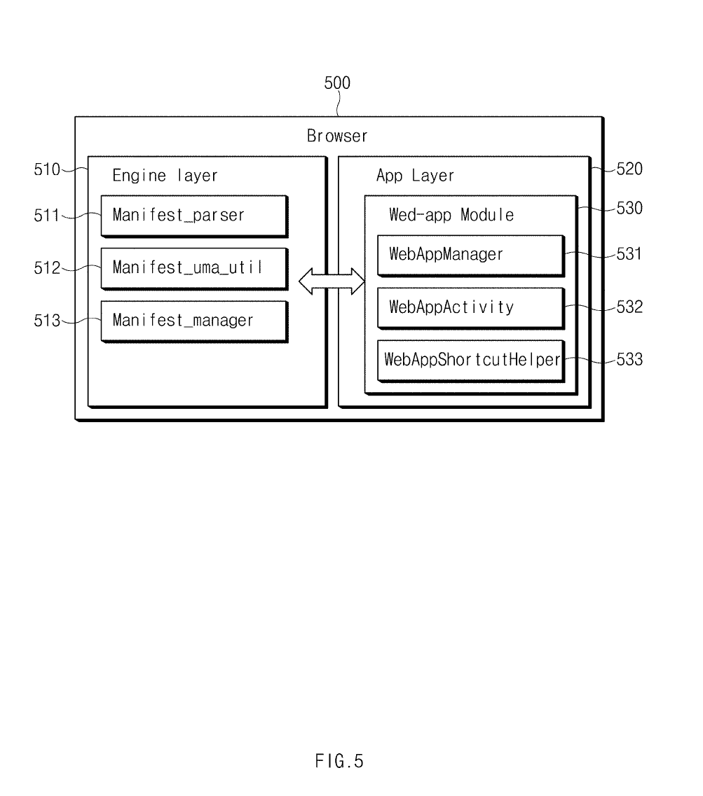

FIG. 5 illustrates a block diagram of a configuration of a browser installed in an electronic device, according to an embodiment of the present disclosure.

Referring to FIG. 5, the electronic device 400 according to an embodiment may execute a browser 500 installed in the electronic device 400. It may be understood that operations mentioned as being performed by the electronic device 400 in the description of FIG. 5 are controlled by the processor 450 of the electronic device 400.

The browser 500 may include an engine layer 510 and an application layer 520.

According to an embodiment, the engine layer 510 may be a module for obtaining data from a web application manifest. The engine layer 510 may be a module associated with the web application manifest and may include a Manifest_parser 511, a Manifest_uma_util 512, and a Manifest_manager 513. The Manifest_parser 511 may parse the web application manifest. The Manifest_parser 511 may obtain information about the icon and the name of a web application for creation of a shortcut, on the basis of a tag or an ID included in the web application manifest. The Manifest_uma util 512 may be a utility class for the Manifest_parser 511. The Manifest_manager 513 may be a module for fetching the manifest. The Manifest_manager 513 may process a callback, a message, and/or the like.

According to an embodiment, the application layer 520 may be a module associated with creating and executing a web application. The application layer 520 may be a module associated with the web application and may include a WebAppManager 531, a WebAppActivity 532, and a WebAppShortcutHelper 533. The WebAppManager 531 may operate as a launcher for the web application. The WebAppManager 531 may be a module for management and control of the web application. The WebAppActivity 532 may be a module for starting to execute the installed web application. The WebAppShortcutHelper 533 may be a helper class for addition of a shortcut.

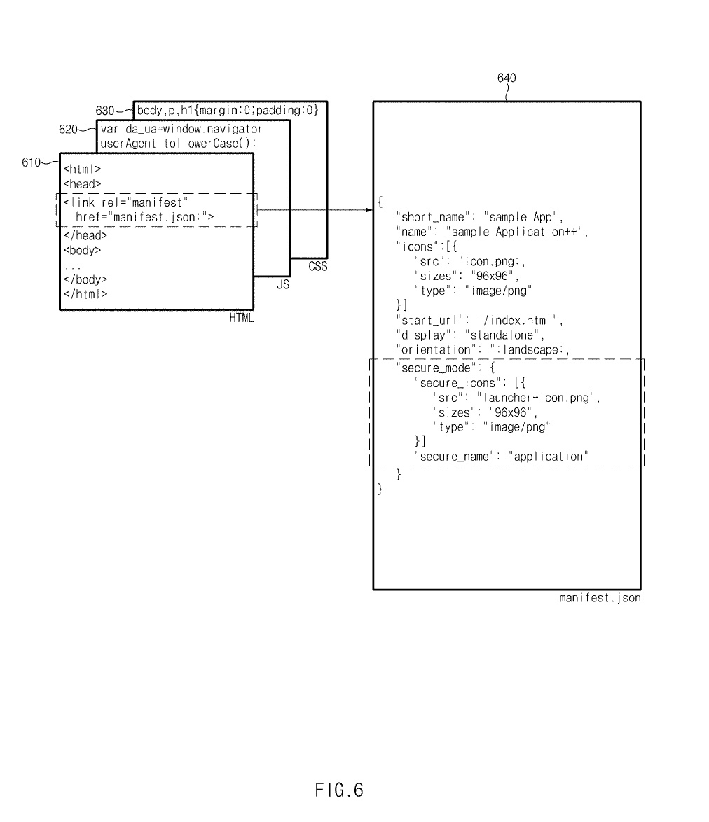

FIG. 6 illustrates an exemplary document included in a web page connected with an electronic device, according to an embodiment of the present disclosure.

Referring to FIG. 6, a web page connected with an electronic device (e.g., the electronic device 101 or 102 of FIG. 1, the electronic device 201 of FIG. 2, or the electronic device 400) according to an embodiment may include a hypertext markup language (HTML) 610, a javascript (JS) 620, and a cascading style sheet (CSS) 630. The electronic device may output the web page on the basis of the HTML 610, the JS 620, and the CSS 630. The HTML 610 may include a code for connection with a web application manifest 640 (manifest.j son) associated with the web page.

According to an embodiment, the web application manifest 640 may include various pieces of information about the web application. For example, the web application manifest 640 may include information for enhancing security when creating a shortcut. For example, the web application manifest 640 may include a tag (“secure_mode”) for creation of a security-enhanced shortcut. “secure_icons” may be a tag including a plurality of pieces of information about the icon of the security-enhanced shortcut. “src” may be a tag including information about the path or file name (e.g., “launcher-icon.png”) of an image to be used as the icon. “sizes” may be a tag including information about the size (e.g., “96×96”) of the icon. “type” may be a tag including information about the type (e.g., “image/png”) of the icon. “secure_name” may be a tag including information about the name (e.g., “application”) of the security-enhanced shortcut.

According to an embodiment, the electronic device may parse the web application manifest 640 to obtain information about the icon and the name of the web application. For example, to enhance the security of the shortcut, the electronic device may obtain information included in a tag for security enhancement that is included in the web application manifest 640.

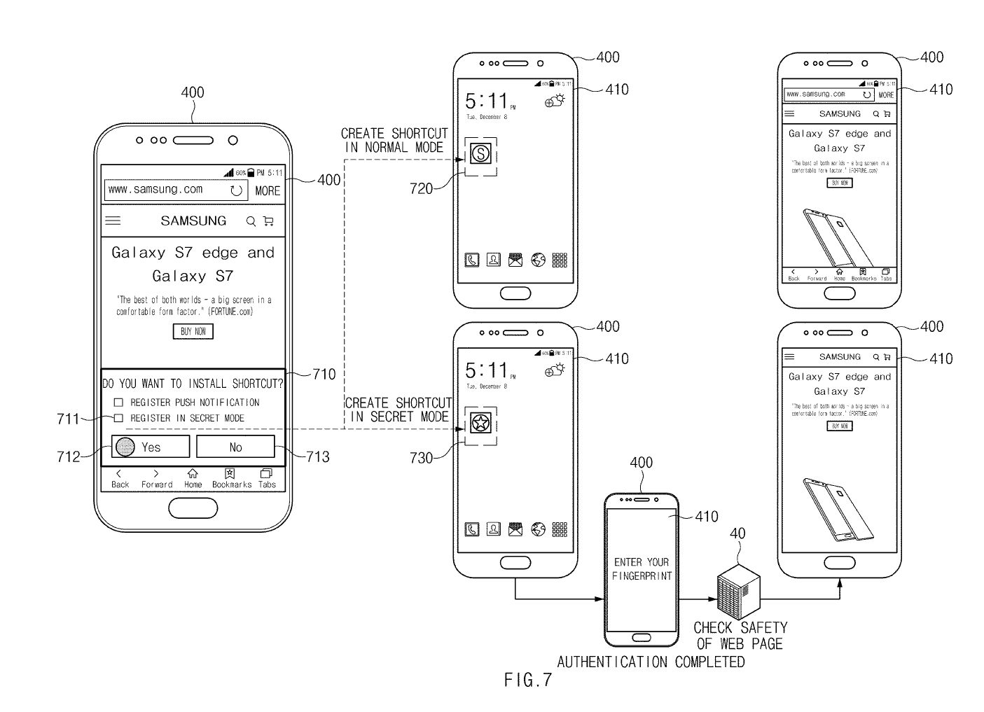

FIG. 7 illustrates an exemplary user interface provided by an electronic device when a shortcut is created or executed of the present disclosure.

Referring to FIG. 7, the electronic device 400 (e.g., the electronic device 101 or 102 of FIG. 1 or the electronic device 201 of FIG. 2) according to an embodiment may display a web page on the display 410. The electronic device 400 may display a popup window 710 for creating a shortcut to the web page. For example, if a web page manifest is included in data of the received web page, the electronic device 400 may display an interface (e.g., the popup window 710) for creating the shortcut. The popup window 710 may include an option 711 for selecting whether to create the shortcut to the web page in a “secret mode”. For example, if the “secret mode” is selected, the electronic device 400 may create the shortcut after encrypting at least a part of the data relating to the web page. The popup window 710 may further include an approve button 712 for approving installation of the shortcut and a cancel button 713 for cancelling installation of the shortcut.

According to an embodiment, in the case where the option 711 is not selected, the electronic device 400 may create a normal shortcut 720. For example, the electronic device 400 may create the shortcut 720 having an icon and a name displayed on a browser when the electronic device 400 accesses the web page. In another example, the electronic device 400 may create the shortcut 720 having a name and an icon that correspond to the information included in the “short_name” (or “name”) and “icons” tags of the web application manifest 640 illustrated in FIG. 6. The electronic device 400 may dispose the shortcut 720 on a screen (e.g., the home screen). If an input to the shortcut 720 is received, the electronic device 400 may display the web page connected with the shortcut 720 on the display 410 through a browser or a web application. The electronic device 400 may display the web page in a normal mode rather than a secret mode of the browser.

According to an embodiment, in the case where the option 711 is selected, the electronic device 400 may create a security-enhanced shortcut 730. For example, the electronic device 400 may encrypt at least a part (e.g., the URI) of the data about the web page when creating the shortcut 730. The electronic device 400 may create the shortcut 730 having an icon and a name that are different from the icon and the name displayed on the browser when the electronic device 400 accesses the web page. For example, the electronic device 400 may create the shortcut 730 having an icon and a name that correspond to the information included in the “secure_mode” tag of the web application manifest 640 illustrated in FIG. 6. The electronic device 400 may dispose the shortcut 730 on a screen (e.g., the home screen).

According to an embodiment, if an input to the shortcut 730 is received, the electronic device 400 may authenticate the user of the electronic device 400. For example, the electronic device 400 may output a user interface to cause the user to enter a fingerprint and may authenticate the user by using the user's fingerprint input.

According to an embodiment, if the authentication is completed, the electronic device 400 may decode the URI corresponding to the shortcut 730. The electronic device 400 may check the safety of the web page corresponding to the decoded URI. The electronic device 400 may check the safety of the web page stored in a server to prevent the electronic device 400 from accessing a dangerous web site through re-direction. FIG. 7 illustrates that the safety of the web page is checked when the electronic device 400 executes the shortcut 730. Without being limited thereto, however, the electronic device 400 may check the safety of the web page if the data about the web page is obtained, or when the shortcut 730 is created.

If it is determined that the web site is safe, the electronic device 400 may display the web page connected with the shortcut 730 on the display 410 through a browser or a web application. For example, the electronic device 400 may operate the browser in a secret mode and may display the web page.

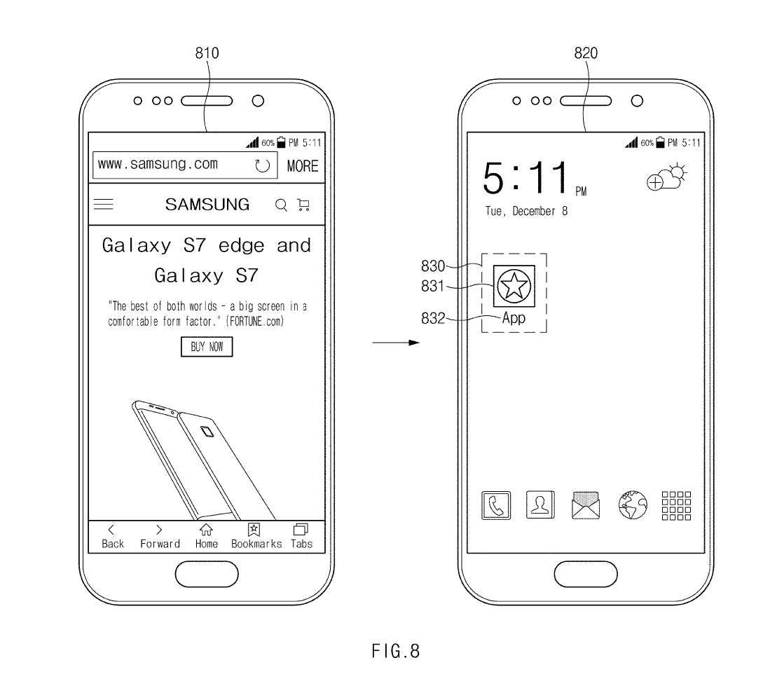

FIG. 8 illustrates a web page connected with an electronic device and a shortcut to the web page, according to an embodiment of the present disclosure.

Referring to FIG. 8, an electronic device (e.g., the electronic device 101 or 102 of FIG. 1, the electronic device 201 of FIG. 2, or the electronic device 400) according to an embodiment may access a web page 810. The electronic device may display the web page 810 through a browser. If the electronic device receives a request to create a shortcut while the web page 810 is being displayed, the electronic device may create a shortcut 830 to the web page 810. For example, if the electronic device receives a request to create a security-enhanced shortcut, the electronic device may create the shortcut 830 after encrypting the URL of the web page 810. In the case where the electronic device creates the shortcut 830 to the web page 810 displayed while the browser is operating in a secret mode, the electronic device may create the shortcut 830 after encrypting the URL of the web page 810. In this case, a name 832 or an icon 831 of the shortcut 830 may be changed.

According to an embodiment, in the case where the web page 810 includes a web application manifest, the electronic device may obtain information about the icon 831 and the name 832 of the shortcut 830 by parsing the web application manifest. The obtained icon 831 and the obtained name 832 may be an icon and a name separately provided by a content provider to prevent a third party from identifying the web page 810. The electronic device may dispose the shortcut 830 having the icon 831 and the name 832 on a screen 820.

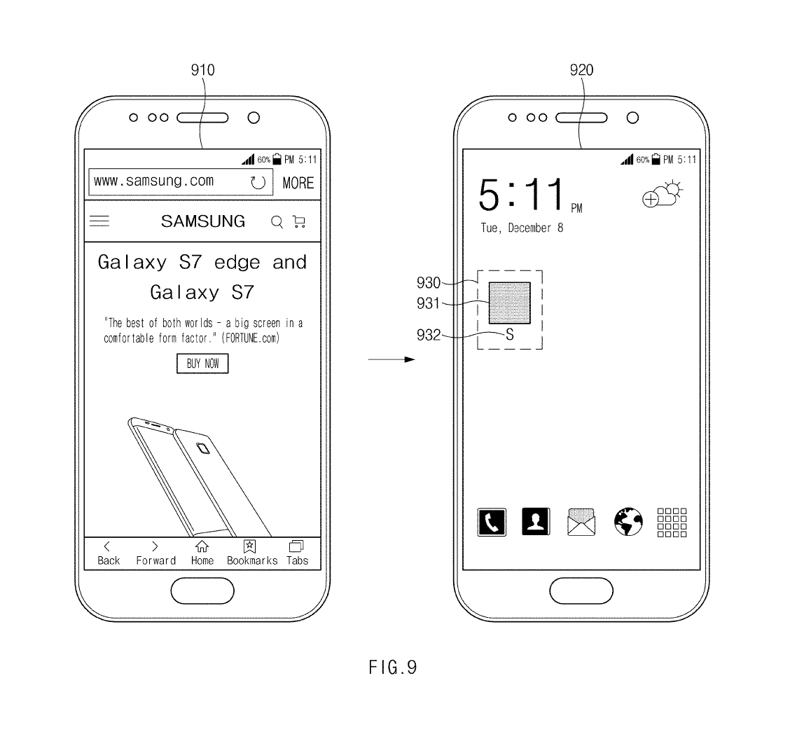

FIG. 9 illustrates a web page connected with an electronic device and a shortcut to the web page, according to an embodiment of the present disclosure.

Referring to FIG. 9, an electronic device (e.g., the electronic device 101 or 102 of FIG. 1, the electronic device 201 of FIG. 2, or the electronic device 400) according to an embodiment may access a web page 910. The electronic device may display the web page 910 through an application (e.g., a browser). If the electronic device receives a request to create a shortcut while the web page 910 is being displayed, the electronic device may create a shortcut 930 to the web page 910. If the electronic device receives a request to create a security-enhanced shortcut, the electronic device may create the shortcut 930 after encrypting or changing at least some information (e.g., the URL) relating to the web page 910. In the case where the electronic device creates the shortcut 930 to the web page 910 displayed while a browser is operating in a secret mode, the electronic device may create the shortcut 930 after encrypting the URL of the web page 910.

According to an embodiment, the electronic device may obtain information about the icon and the name of the web page 910 when accessing the web page 910. The electronic device may not use the icon and the name included in the web page 910 to prevent a third party from viewing the icon and the name of the shortcut 930 to identify the web page 910. The electronic device may change the icon and the name. According to an embodiment, the electronic device may set an icon 931 and a name 932 of the shortcut 930 to a specified icon and a specified name. For example, the electronic device may set the icon 931 of the shortcut 930 to a monochromatic icon. The electronic device may set the name 932 of the shortcut 930 to a specified name. In another example, the electronic device may set the icon 931 and the name 932 of the shortcut 930 by changing the icon and the name of the web page 910 on the basis of a specified rule. For example, the electronic device may create the icon 931 of the shortcut 930 on the basis of the color of an icon of the web page 910. The electronic device may set the first letter of the name of the web page 910 to the name of the shortcut 930.

The electronic device may dispose the shortcut 930 having the changed icon 931 and the changed name 932 on a screen 920 (e.g., the home screen).

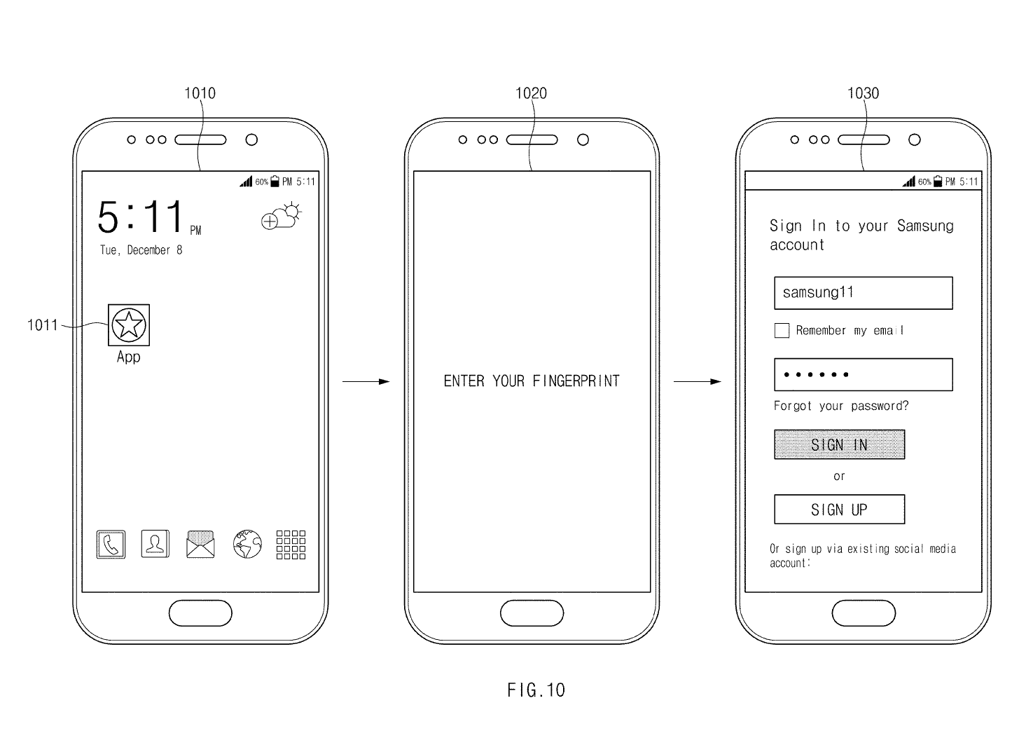

FIG. 10 illustrates a web page connected with an electronic device, a shortcut to the web page, and a user interface for authentication, according to an embodiment of the present disclosure.

Referring to FIG. 10, an electronic device (e.g., the electronic device 101 or 102 of FIG. 1, the electronic device 201 of FIG. 2, or the electronic device 400) according to an embodiment may dispose a shortcut 1011 on a screen 1010 (e.g., the home screen). If a user input to the shortcut 1011 is detected, the electronic device may display an authentication screen 1020 to cause a user to enter a fingerprint for user authentication. If the user is completely authenticated, the electronic device may display a web page 1030 corresponding to the shortcut 1011 through a browser.

According to an embodiment, the electronic device may display the web page 1030 including a log-in screen. Alternatively, if the user authentication is completed on the authentication screen 1020, the electronic device may display an automatically logged-in web page rather than a separate log-in screen. In the case where the user authentication is completed, the electronic device may automatically enter the user's stored ID and password if the web page 1030 including the log-in screen is displayed. The user's ID and password associated with the web page 1030 may be managed separately from the user's ID and password associated with a different web page. Since the user authentication is performed at the time of access to the web page 1030, the user's ID and password may be kept secure even though automatically entered.

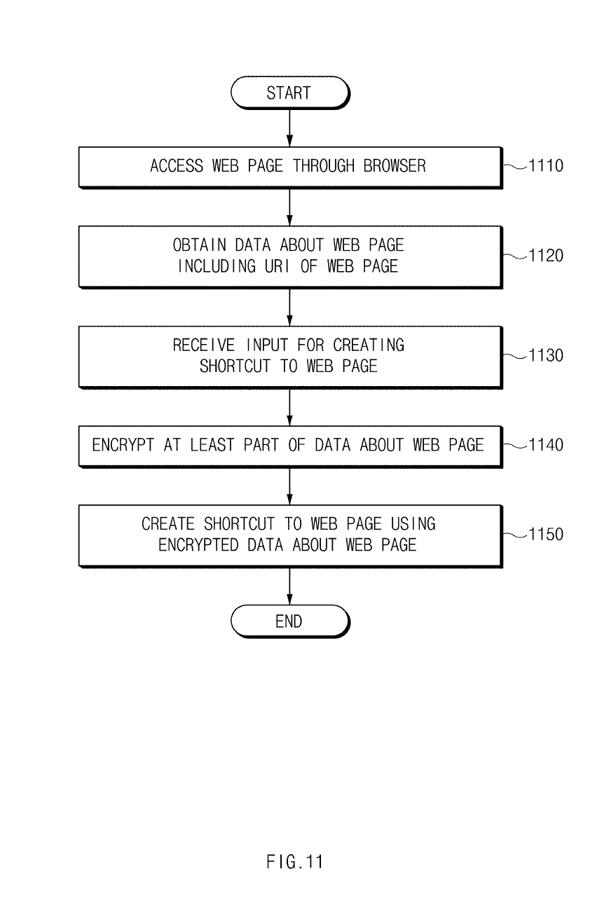

FIG. 11 illustrates a flowchart of a method for creating a shortcut to a web page in an electronic device, according to an embodiment of the present disclosure.

Hereinafter, it is assumed that the electronic device 400 of FIG. 4 performs the process illustrated in FIG. 11. Furthermore, it may be understood that operations mentioned as being performed by the electronic device 400 in the description of FIG. 11 are controlled by the processor 450 of the electronic device 400.

Referring to FIG. 11, in operation 1110, the electronic device may access a web page through an application (e.g., a browser). For example, the electronic device may access a web page stored in a server and may display the web page on the display by using a browser.

In operation 1120, the electronic device may obtain data about the web page that includes the URI of the web page. For example, the electronic device may obtain data about the URI, the icon, the name, and the like of the web page when accessing the web page. In another example, the electronic device may parse a web application manifest of the web page to obtain data about the URI, the icon, the name, and the like of the web page.

In operation 1130, the electronic device may receive an input for creating a shortcut to the web page. For example, the electronic device may receive the input through a user interface to inquire whether to create the shortcut.

In operation 1140, the electronic device may encrypt at least a part of the data about the web page. For example, the electronic device may encrypt the URI of the web page by using a key managed by the browser.

In operation 1150, the electronic device may create the shortcut to the web page by using the encrypted data about the web page. For example, the electronic device may change the icon and the name of the web page obtained at the time of access to the web page, and may apply the changed icon and the changed name to the shortcut. In another example, the electronic device may apply, to the shortcut, an icon and a name included in a security-related tag included in the web application manifest.

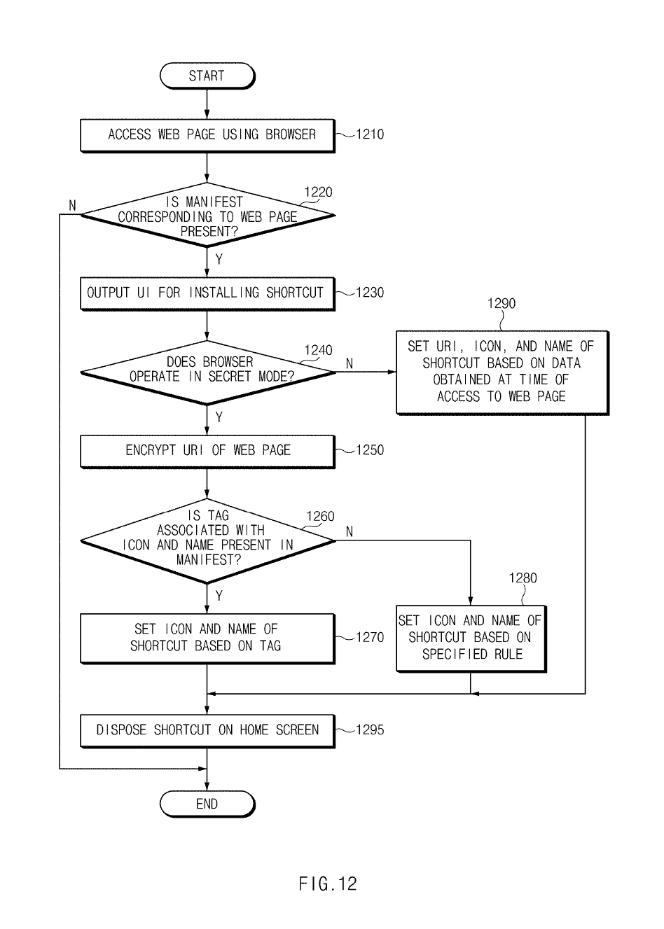

FIG. 12 illustrates a flowchart illustrating a method for creating a shortcut to a web page in an electronic device, according to an embodiment of the present disclosure.

Hereinafter, it is assumed that the electronic device 400 of FIG. 4 performs the process illustrated in FIG. 12. It may be understood that operations mentioned as being performed by the electronic device 400 in the description of FIG. 12 are controlled by the processor 450 of the electronic device 400.

Referring to FIG. 12, in operation 1210, the electronic device may access a web page by using an application (e.g., a browser). For example, the electronic device may render the connected web page by using the browser.

In operation 1220, the electronic device may determine whether the web page includes a web application manifest. For example, in the case where the web page provides a web application, the electronic device may determine a presence or absence of a web application manifest corresponding to the web page provided by a content provider.

In the case where the manifest corresponding to the web page is present, the electronic device may, in operation 1230, output a user interface (UI) for installation of a shortcut. For example, if the web application manifest is recognized, the electronic device may output a popup window to inquire whether to install the shortcut to the web page.

If a request to install the shortcut is received through the UI, the electronic device may, in operation 1240, determine whether the browser operates in a secret mode. For example, the electronic device may determine whether, between a normal mode and a secret mode provided by the browser, the browser operates in the secret mode.

In the case where the browser operates in the secret mode, the electronic device may, in operation 1250, encrypt at least a part (e.g., the URI) of data about the web page. For example, the electronic device may encrypt the URI of the web page by using a key stored therein.

In operation 1260, the electronic device may determine whether a tag associated with an icon and a name is present in the manifest. For example, the electronic device may determine whether the web application manifest contains a tag including information about an icon and a name that are to be used for the shortcut for the secret mode. The tag contained in the web application manifest may include information for security enhancement, which may be, for example, a code associated with an icon and a name that prevent a third party from recognizing the web page corresponding to the manifest.

In the case where the tag associated with the icon and the name for security enhancement is present in the manifest, the electronic device may, in operation 1270, set the icon and the name of the shortcut on the basis of the tag. For example, the electronic device may set an image file written in the tag to the icon of the shortcut. The electronic device may set a name written in the tag to the name of the shortcut.

In the case where the tag associated with the icon and the name for security enhancement is not present in the manifest, the electronic device may, in operation 1280, set the icon and the name of the shortcut on the basis of a specified rule. For example, the electronic device may set one of specified monochromatic images to the icon of the shortcut. The electronic device may set one of specified names to the name of the shortcut. In another example, the electronic device may set the icon of the shortcut on the basis of a color of an icon acquired when the electronic device accesses the web page. The electronic device may set the first letter of the name of the web page acquired when the electronic device accesses the web page, to the name of the shortcut.

In the case where the browser operates in the normal mode, the electronic device may, in operation 1290, set the URI, the icon, and the name of the shortcut on the basis of data acquired when the electronic device accesses the web page. For example, the electronic device may set the icon and the name of the shortcut to an icon and a name that are to be exposed to a user when the electronic device accesses the web page, without encrypting the URI.

In operation 1295, the electronic device may dispose the shortcut on a screen (e.g., the home screen).

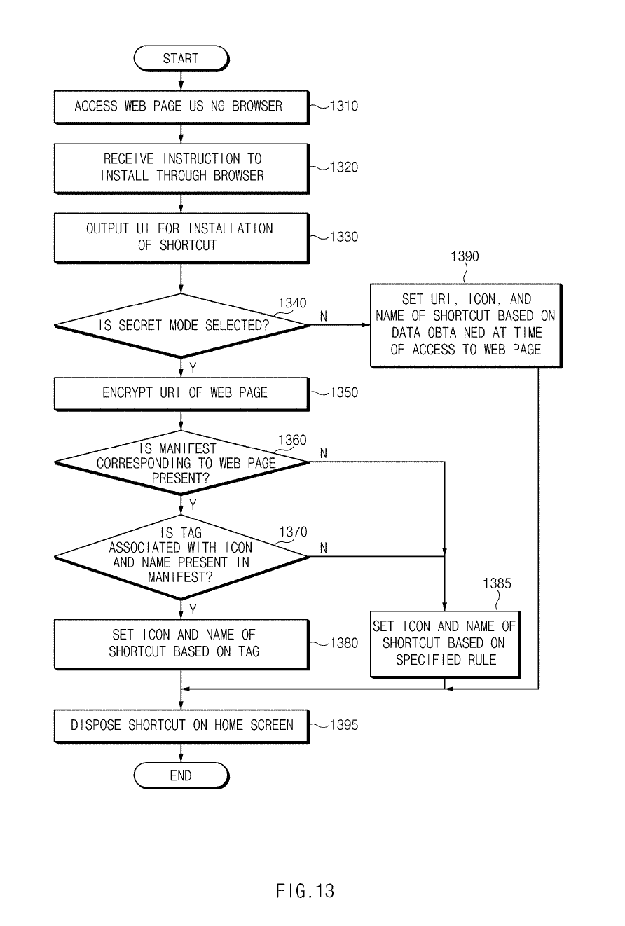

FIG. 13 illustrates a flowchart of a method for creating a shortcut to a web page in an electronic device, according to an embodiment of the present disclosure.

Hereinafter, it is assumed that the electronic device 400 of FIG. 4 performs the process illustrated in FIG. 13. It may be understood that operations mentioned as being performed by the electronic device 400 in the description of FIG. 13 are controlled by the processor 450 of the electronic device 400. Repetitive description of the operations described with reference to FIG. 12 will be omitted for the convenience of description.

Referring to FIG. 13, in operation 1310, the electronic device may access a web page by using an application (e.g., a browser).

In operation 1320, the electronic device may receive, through the browser, an instruction to install a shortcut. For example, the browser may display a menu for installation of the shortcut. The electronic device may start to install the shortcut if a user input is applied to the menu of the browser for installation of the shortcut.

If the instruction to install the shortcut is received, the electronic device may, in operation 1330, output a UI for installation of the shortcut. For example, the electronic device may output a UI associated with installation of the shortcut to the web page. The UI may include, for example, an option for selecting a normal mode or a secret mode.

In operation 1340, the electronic device may determine whether the secret mode has been selected. For example, the electronic device may determine whether the secret mode has been selected, based on the status of the option included in the UI illustrated in FIG. 7 for selecting a normal mode or a secret mode.

In the case where the secret mode has been selected, the electronic device may, in operation 1350, encrypt at least a part (e.g., the URI) of data about the web page.

In operation 1360, the electronic device may determine whether a manifest corresponding to the web page is present.

In the case where the manifest corresponding to the web page is present, the electronic device may, in operation 1370, determine whether a tag associated with an icon and a name is present in the manifest. For example, the electronic device may determine whether the web application manifest contains a tag including information about an icon or a name that is to be used in the secret mode.

In the case where the tag associated with the icon and the name is present in the manifest, the electronic device may, in operation 1380, set the icon and the name of the shortcut on the basis of the tag.

In the case where the manifest corresponding to the web page is not present, or in the case where the tag associated with the icon and the name is not present in the manifest, the electronic device may, in operation 1385, set the icon and the name of the shortcut on the basis of a specified rule.

In the case where the normal mode has been selected, the electronic device may, in operation 1390, set the URI, the icon, and the name of the shortcut on the basis of data acquired when the electronic device accesses the web page.

In operation 1395, the electronic device may dispose the shortcut on a screen (e.g., the home screen).

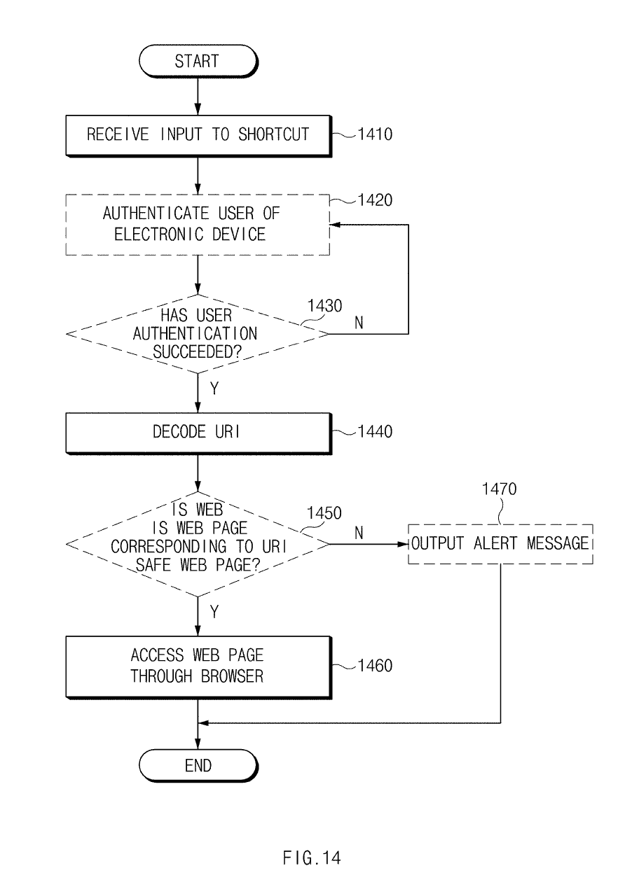

FIG. 14 illustrates a flowchart of a method for executing a shortcut to a web page in an electronic device, according to an embodiment of the present disclosure.

Hereinafter, it is assumed that the electronic device 400 of FIG. 4 performs the process illustrated in FIG. 14. It may be understood that operations mentioned as being performed by the electronic device 400 in the description of FIG. 14 are controlled by the processor 450 of the electronic device 400.

Referring to FIG. 14, in operation 1410, the electronic device may receive an input to a security-enhanced shortcut. For example, the electronic device may receive a user's touch input to coordinates at which the security-enhanced shortcut is displayed. If the touch input is received, the electronic device may execute the security-enhanced shortcut.

In operation 1420, the electronic device may authenticate the user of the electronic device. For example, the electronic device may authenticate the user by using biometric authentication (e.g., a fingerprint), a PIN, an authentication pattern, and/or the like.

In operation 1430, the electronic device may determine whether the user authentication has succeeded. For example, the electronic device may compare the fingerprint, the PIN, or the authentication pattern input by the user with the fingerprint, the PIN, or the authentication pattern stored in advance. If the fingerprint, the PIN, or the authentication pattern input by the user is identical to the fingerprint, the PIN, or the authentication pattern stored in advance, the electronic device may determine that the user authentication has succeeded.

According to an embodiment, operation 1420 and operation 1430 may be optional elements and may be omitted. In the case where operation 1420 and operation 1430 are omitted, the electronic device may perform operation 1440 after operation 1410.

In the case where the authentication has succeeded, the electronic device may, in operation 1440, decode a URI. For example, the electronic device may decode the URI by using the key used to encrypt the URI.

In operation 1450, the electronic device may determine whether a web page corresponding to the URI is a safe web page. For example, the electronic device may verify whether the web page corresponds to a web page that does not have a problem, such as a malicious code, redirection, or the like.

According to an embodiment, operation 1450 may be an optional element and may be omitted. In the case where operation 1450 is omitted, the electronic device may perform operation 1460 after operation 1440.

In the case where the web page corresponds to a safe web page, the electronic device may, in operation 1460, access the web page through a browser. For example, the electronic device may access the web page in a secret mode so as not to leave a history relating to the web page. In another example, the electronic device may access the web page in a normal mode.

In the case where the web page does not correspond to a safe web page, the electronic device may, in operation 1470, output an alert message. For example, the electronic device may output a message to inform the user of the problem, such as a malicious code, redirection, or the like, without access to the web page. In the case where operation 1450 is omitted, operation 1470 may also be omitted.

The term “module” used in this disclosure may include a unit composed of hardware, software and firmware and may be interchangeably used with the terms “unit”, “logic”, “logical block”, “component” and “circuit”. The “module” may be an integrated component or may be a minimum unit for performing one or more functions or a part thereof. The “module” may be implemented mechanically or electronically and may include at least one of an application-specific IC (ASIC) chip, a field-programmable gate array (FPGA), and a programmable-logic device for performing some operations, which are known or will be developed. At least a part of an apparatus (e.g., modules or functions thereof) or a method (e.g., operations) according to various embodiments may be, for example, implemented by commands stored in computer-readable storage media (e.g., the memory 130) in the form of a program module. The instruction, when executed by a processor (e.g., the processor 120), may cause the processor to perform a function corresponding to the instruction. A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and an internal memory. Also, a program instruction may include not only a mechanical code such as things generated by a compiler but also a high-level language code executable on a computer using an interpreter. A module or a program module according to various embodiments may include at least one of the above elements, or a part of the above elements may be omitted, or other elements may be further included. Operations performed by a module, a program module, or other elements according to various embodiments may be executed sequentially, in parallel, repeatedly, or in a heuristic method or some operations may be executed in different sequences or may be omitted. Alternatively, other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a communication circuit;
a memory configured to store an application;
a display; and
at least one processor operably coupled to the communication circuit, the memory, and the display,
wherein the at least one processor is configured to:
receive data about a web page through the application using the communication circuit;
receive an input for creating a shortcut to the web page;
encrypt at least a part of the data about the web page that includes a uniform resource identifier (URI) of the web page, based on the input; and
create the shortcut to the web page associated with the encrypted data.

2. The electronic device of claim 1, wherein the at least one processor is further configured to:
obtain the data about the web page based on a web application manifest corresponding to the web page.

3. The electronic device of claim 2, wherein the web application manifest corresponding to the web page includes an icon and a name of the shortcut, and
wherein the at least one processor is configured to:
create the shortcut using the icon and the name.

4. The electronic device of claim 1, wherein the at least one processor is further configured to:
output, on the display, a user interface including an option for selecting whether to perform the encryption; and
encrypt the at least a part of the data about the web page if the option is selected.

5. The electronic device of claim 1, wherein the at least one processor is further configured to:
encrypt the at least a part of the data about the web page if the processor accesses the web page while the application is executed in a secret mode.

6. The electronic device of claim 1, wherein the at least one processor is further configured to:
obtain the data about the web page that includes the URI of the web page, information about an icon of the web page, and information about a name of the web page; and
change the information about the icon of the web page and the information about the name of the web page.

7. The electronic device of claim 1, wherein the at least one processor is further configured to:
set an icon and a name of the shortcut to a specified icon and a specified name.

8. The electronic device of claim 1, wherein the at least one processor is further configured to:
check safety of the web page before access to the web page.

9. The electronic device of claim 1, wherein the at least one processor is further configured to:
dispose the shortcut on a screen output on the display;
perform authentication on a user of the electronic device if an input is applied to the shortcut output on the display; and
output the web page on the display through the application if the authentication is completed.

10. The electronic device of claim 9, wherein the at least one processor is further configured to:
authenticate the user of the electronic device using at least one of biometric information, a personal identification number (PIN), or an authentication pattern.

11. The electronic device of claim 9, wherein the at least one processor is further configured to:
automatically enter an ID and a password for logging in to the web page if the authentication is completed.

12. The electronic device of claim 9, wherein the at least one processor is further configured to:
decode the encrypted data about the web page if the authentication is completed.

13. The electronic device of claim 9, wherein the at least one processor is further configured to:
check safety of the web page if the authentication is completed.

14. The electronic device of claim 9, wherein the at least one processor is further configured to:
execute the application in a secret mode if the authentication is completed.

15. A method for creating a shortcut to a web page in an electronic device, the method comprising:
accessing the web page through an application from a server;
obtaining data about the web page that includes a URI of the web page;
encrypting at least a part of the data about the web page; and
creating a shortcut to the web page associated with the encrypted data.

16. The method of claim 15, wherein the obtaining of the data includes:
obtaining the data about the web page based on a web application manifest corresponding to the web page.

17. The method of claim 15, further comprising:
outputting a user interface including an option for selecting whether to perform the encryption,
wherein the encrypting of the at least a part of the data includes:
encrypting the at least a part of the data about the web page if the option is selected.

18. The method of claim 15, wherein the encrypting of the at least a part of the data includes:
encrypting the at least a part of the data about the web page if the electronic device accesses the web page while the application is executed in a secret mode.

19. The method of claim 15, wherein the obtaining of the data comprises:
obtaining the data about the web page that includes the URI of the web page, information about an icon of the web page, and information about a name of the web page, and
wherein the encrypting of the at least a part of the data comprises:
changing the information about the icon of the web page and the information about the name of the web page.

20. A non-transitory computer-readable medium embodying a computer program, the computer program comprising computer readable program code that when executed by at least one processor causes the at least one processor to:
access a web page through an application from a server;
obtain data about the web page that includes a URI of the web page;
encrypt at least a part of the data about the web page; and
create a shortcut to the web page associated with the encrypted data.
